(19) United States
(12) Patent Application Publication
(10) Pub. No.: US 2003/0043033 A1
(43) Pub. Date: Mar. 6, 2003

(54) Vehicle safety warning control system

(76) Inventor: Gul Nam Lee, Norwalk, CA (US)

Correspondence Address: JONATHAN Y. KANG, ESQ., LEE & HONG P.C., 11th Floor, 221 N. Figueroa Street, Los Angeles, CA, 90012-2601, US

(21) Appl. No.: 09/942,063

(22) Filed: Aug. 28, 2001

(51) Int. Cl. B60Q 1/26

(52) U.S. Cl. 340/463; 340/464

(57) ABSTRACT

A vehicle safety warning control system comprises an accelerator pedal sensor associated with an accelerator pedal, a brake pedal sensor associated with a brake pedal to detect a normal braking and a panic braking, an impact sensor comprising an impact switch and a processor to detect collision, and a relay connected to the accelerator pedal sensor, the brake pedal sensor and the impact sensor. The relay controls at least one of brake lights and additional lights in response to the brake pedal sensor and the impact sensor. The accelerator pedal has a sensor switch disposed on the accelerator pedal to detect removal of pressure imposed thereon. When the sensor switch in enabled, the accelerator pedal sensor causes the brake lights to be energized at a less than full intensity.

### BACKGROUND OF THE INVENTION

1. Field of the Invention

This invention relates to a motor vehicle safety system, and particularly, to a safety warning control system designed to provide an early warning of deceleration and braking to reduce rear end collision and an emergency warning after collision.

2. Description of the Related Art

Modem vehicles are equipped with a brake lighting system to warn the approaching drivers of deceleration and braking. Many serious accidents, particularly on today's high-speed highways, are caused by the deceleration of a lead vehicle which is incorrectly judged by the approaching vehicle such that a rear end collision results.

Many different passive protection systems have been used by which the consequences of accidents are reduced. However, the development of brake lights has failed to significantly reduce the rear end collisions. In the United States, a center-mounted third brake light has been introduced to reduce vehicle collisions.

The conventional brake system activates that rear brake lights on actuation of the foot brake and not whenever the vehicle coasts without the actuation of the brake. Such action may lead to deceleration both at a high speed and at a low speed. Therefore, even by removing one's foot from the accelerator pedal for a time of several seconds, a speed differential in relation the vehicle behind is established, which involves the danger of a rear end collision without the brake light being turned on.

Such brake system has no contribution after an accident. When accident occurs, the brake lights are usually turned off unless the driver rests his foot on the brake pedal. Although an alert driver may turn on the emergency lights, such lights cannot be enabled if the driver is rendered unconscious or disabled. In addition, there is no reasonable way of determining whether the emergency is related to accidents or by mechanical failure, such as deflated tire.

To alleviate the above problems, some newer automobiles and trucks are equipped with an expensive satellite communication system. One problem with such system is that it must be activated by a user, such as a driver.

### SUMMARY OF THE INVENTION

Accordingly, the present invention is directed to a vehicle safety warning control system that substantially obviates one or more of the problems due to limitations and disadvantages of the related art.

It is an object of the present invention to provide a control system to detect braking condition of the vehicle and to alert nearby drivers of such condition through the warning lights installed in the vehicle.

It is another object of the present invention to provide an automated collision warning system when the vehicle is involved in an accident.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a vehicle safety warning control system for use with a fuse box having a brake light fuse comprises a brake pedal sensor associated with a brake pedal to detect a normal braking and a panic braking; an impact sensor comprising an impact switch and a processor to detect collision; and a relay connected to the brake pedal sensor and the impact sensor, wherein the relay controls at least one of brake lights and additional lights, such as a strobe light, in response to the brake pedal sensor and the impact sensor.

According to one aspect of the present invention, the control system further includes a flasher connected to the relay, the flasher being energized in response to outputs of the brake pedal sensor and the impact sensor.

According to another aspect of the present invention, when the brake pedal sensor detects the panic braking, the relay energizes the additional lights.

According to another aspect of the present invention, the impact sensor is triggered by an airbag switch. Preferably, when the impact switch is triggered, the processor activates at least one of hazard lights, emergency transmitter and door unlock mechanism.

According to another embodiment of the present invention, a vehicle safety warning control system comprises an accelerator pedal sensor associated with an accelerator pedal; a brake pedal sensor associated with a brake pedal to detect a normal braking and a panic braking; an impact sensor comprising an impact switch and a processor to detect collision; and a relay connected to the accelerator pedal sensor, the brake pedal sensor and the impact sensor, wherein the relay controls at least one of brake lights and additional lights in response to the brake pedal sensor and the impact sensor.

According to one aspect of the present invention, the accelerator pedal has a sensor switch disposed on the accelerator pedal to detect removal of pressure imposed thereon. When the sensor switch in enabled, the accelerator pedal sensor causes the brake lights to be energized at a less than full intensity.

It is to be understood that both the foregoing general description and the following detailed description are exemplary and explanatory and are intended to provide a further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 illustrates an accelerator pedal equipped with a pressure sensitive switch;

FIG. 2 illustrates the movement of the brake pedal from a normal position to various braking positions;

FIG. 3 illustrates a rear view of a conventional vehicle;

FIG. 4 illustrates a block diagram of the vehicle safety warning control system according to a first embodiment of the present invention;

FIG. 5 illustrates a schematic diagram of the vehicle safety warning control system according to a second embodiment of the present invention; and

FIG. 6 illustrates a schematic diagram of the vehicle safety warning control system according to a third embodiment of the present invention.

### DETAILED DESCRIPTION OF THE PREFERRED EMBODIMENTS

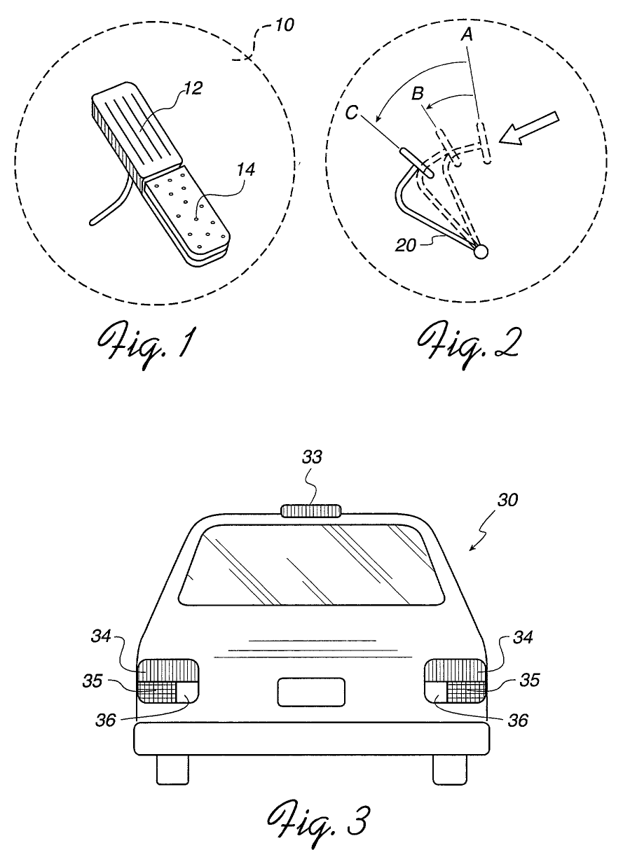

With reference to the drawings, and in particular to FIGS. 1-6 thereof, a vehicle safety warning control system embodying the principles and concepts of the present invention will be described.

FIG. 1 illustrates an accelerator pedal 10 equipped with a pressure sensitive switch for use in the vehicle safety warning control system. The accelerator pedal 10 comprises a main pedal 12 and a sensor switch 14 preferably attached on the lower portion of the main pedal. The sensor switch 14 has a planar configuration and has substantially the same width as the main pedal 12. The sensor switch 14 is sensitive to foot pressure applied thereon and is well known to one of ordinary skill in the art. The use of the sensor switch 14 in the present invention is to reduce the inherent time delay between the removing of a foot from the accelerator pedal and pressing down on the brake pedal thereafter.

Alternative to the pressure sensitive sensor switch 14, a mercury switch may be used by physically attaching the switch to the back of the accelerator pedal.

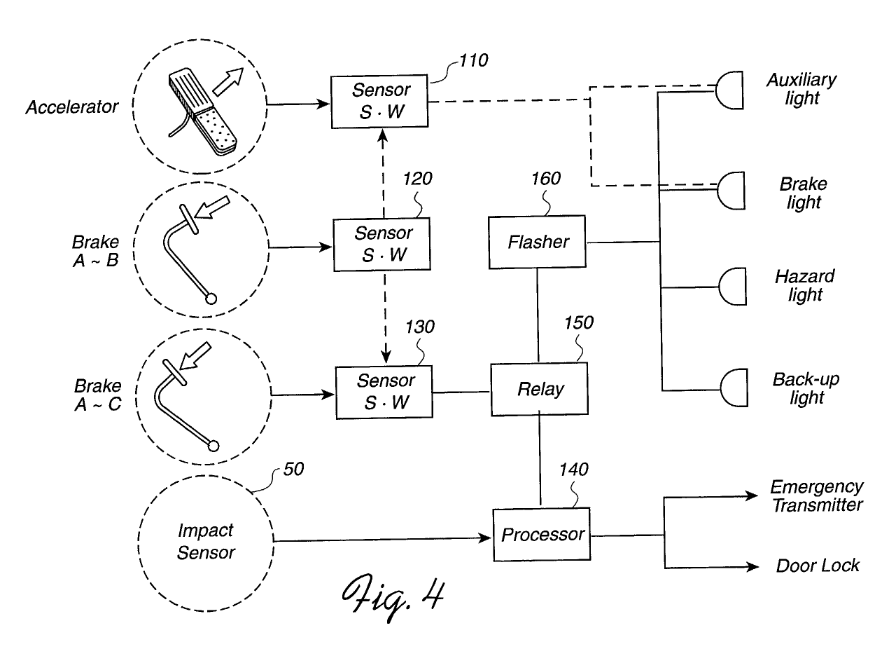

FIG. 2 illustrates the movement of the brake pedal 20 from a normal position A to a braking position B or C. Referring to FIG. 2, when the vehicle is brought to stop by applying normal braking force, the brake pedal 20 moves from position A to position B. However, when the driver encounters a panic stop condition, such as sudden stop to avoid a debris on the road, a higher foot pressure is applied on the brake pedal 20. As a result, the brake pedal 20 typically moves from position A to position C during a panic stop condition.

FIG. 3 illustrates a rear view of a conventional vehicle. In the United States, the vehicle 30 must be equipped with a number of lights for use as a warning system to others. In that regard, the vehicle 30 shown in FIG. 3 is equipped with an auxiliary light 33 located near to top of the vehicle 30, brake lights 34, hazard or signal lights 35 and back-up (reverse) lights 36.

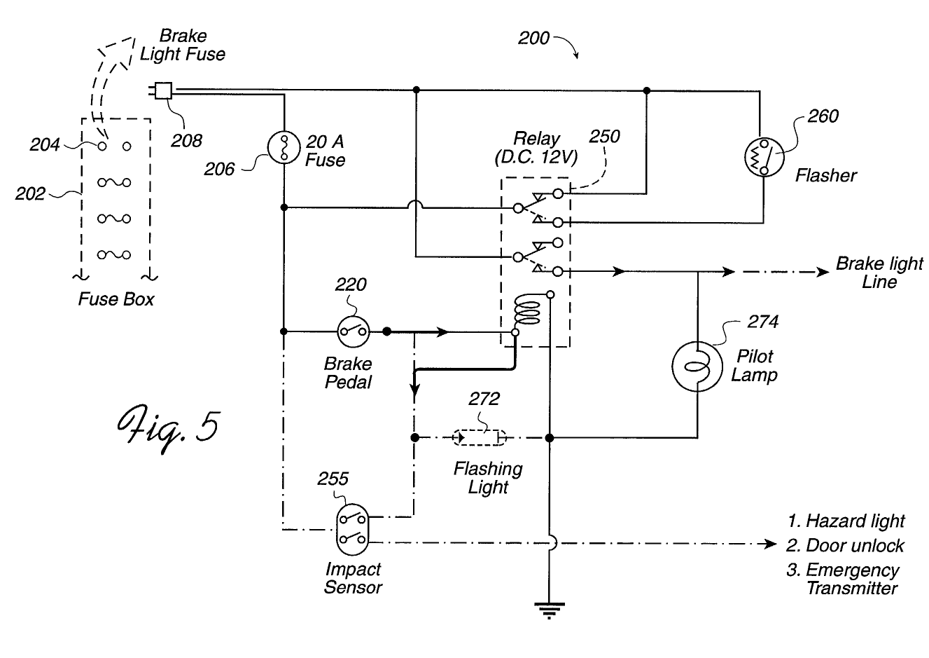

FIG. 4 illustrates a block diagram of the vehicle safety warning control system 100 according to a first embodiment of the present invention. According to the first embodiment, the vehicle safety warning control system 100 comprises an accelerator sensor 110, a first brake sensor 120, a second brake sensor 130, an impact sensor/processor 140, a relay 150 and a flasher 160.

The accelerator sensor 110 is connected to the sensor switch 14 of the accelerator pedal 10 shown in FIG. 1. Preferably, the accelerator sensor 110 is the sensor switch 14. The output of the accelerator sensor 110 is preferably connected to the auxiliary light 33 and the brake lights 34. Preferably, when the accelerator sensor 110 detects that the foot is removed from the accelerator pedal 10, the accelerator sensor 110 turns on the auxiliary light 33 and the brake lights 34 in one-half of the normal intensity to warn the others that the vehicle is preparing to slow down.

The first brake sensor 120 is connected to the brake pedal 20. The output of the brake sensor 120 is also connected to the auxiliary light 33 and the brake lights 34. When normal braking condition is detected, the brake sensor 120 energizes the auxiliary light 33 and the brake lights 34 to full intensity.

The second brake sensor 130 is also connected to the brake pedal 20. The output of the brake sensor 130 is connected to the relay 150 which is connected, for example, to the auxiliary light 33, brake lights 34, hazard lights 35 and back-up lights 36 through the flasher 160. Although drawn separately for purposes of discussion, the first and the second brake sensor 120 and 130 are preferably of one sensing unit capable of detecting the difference between a normal braking condition and panic braking condition. One such sensor utilizes a fluid pressure switch device, wherein the fluid pressure is created by the actuating movement of the brake pedal. When a sudden force is applied to the brake pedal, a high fluid pressure is created in a short time.

A fluid pressure switching device that is closed when the force applied to the actuator of the braking system is representative of panic braking. An example of such fluid pressure switching device is described in U.S. Pat. No. 3,939,316 to Stropkay, which is hereby incorporated by reference. Alternative to the fluid pressure switching device, other suitable sensors known to one of ordinary skill in the art may also be used. For example, a brake switch may be installed underneath the brake pedal in such a way that when the brake pedal is depressed in a normal driving and stop condition, the brake switch is not triggered.

According to the first embodiment of the present invention, during the panic stop condition, the brake sensor 130 is triggered and output a signal that activates the relay 150. The relay 150 is energized which in turn energizes the flasher 160. The flasher 160 is preferably a simple timer that turns on and off the lights in a predetermined periodic sequence. The flasher 160 is well known to one of skill in the art and is commonly used in motor vehicles to control the turn signals.

When the flasher is energized, the lights connected thereto begin flashing. For example, if the auxiliary light 33, brake lights 34, hazard lights 35 and back-up lights 36 are connected to the flasher 160, then such lights all begin to flash, thus signaling others that the present vehicle is in a panic stop mode. Any combination of lights may be connected to the flasher without deviating from the gist of the present invention.

Referring to FIG. 4, there is also provided an impact sensor 50 connected to a processor 140. When the vehicle is involved in an accident, such as being hit from behind, the impact sensor 50 is triggered which is detected by the processor 140. The processor 140 processes the input from the impact sensor 50 and outputs a signal to open door locks and to enable emergency transmitter to issue assistance request message, preferably using a GPS system presently being used in many new cars. The processor 140 also enables the relay 150 to turn on the warning lights connected to the flasher 160 to issue visual warning to near by drivers.

According to the preferred embodiment of the present invention, the impact sensor 50, preferably installed on the front and/or rear bumper of the vehicle, is activated when the vehicle is involved in a collision. Additional impact sensors may be placed on the side panels of the vehicle, for example, in a form of a body guard strip, to detect side collisions.

The impact sensor 50 may be of the type which is used to activate airbags installed in a vehicle. Another type of impact sensor may be a telescoping type switch in which a first telescoping member is fixed to the motor vehicle and a second telescoping member slidably disposed inside the first telescoping member. Upon impact, the second telescoping member retracts into the first telescoping member thus closing a switch disposed therein. Such impact sensor is described in U.S. Pat. No. 5,408,214 to Chalmers et al.

Alternatively, the impact sensor 50 may include a tiltable mercury switch or a type of switch capable of detecting tilting motion or sudden impact. For example, a decorative switch that incorporates such mercury switch or impact switch may be connected to the dash board or a steering wheel.

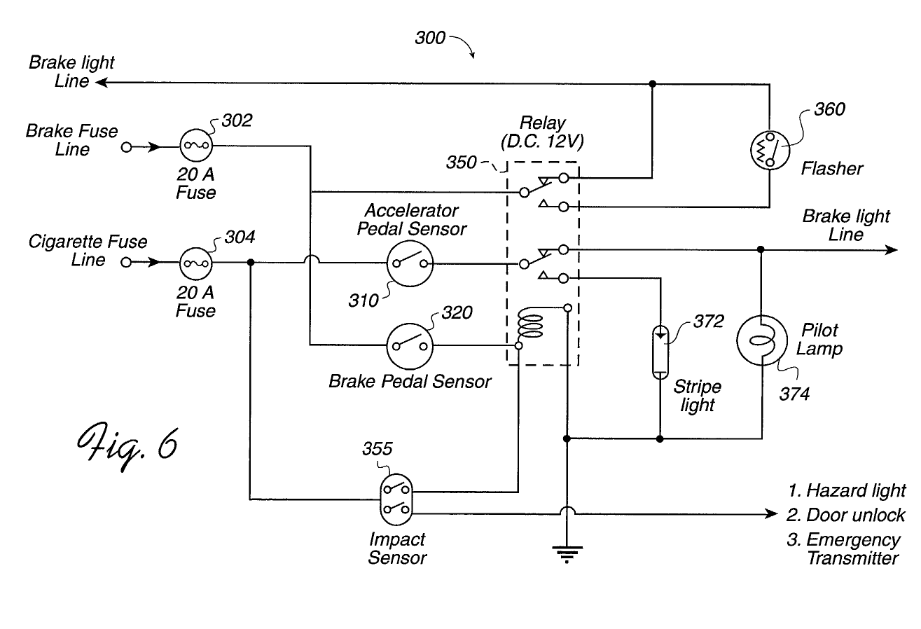

FIG. 5 illustrates a schematic diagram of the vehicle safety warning control system 200 according to a second embodiment of the present invention. The vehicle safety warning control system 200 is preferably to be used with a vehicle equipped with a conventional fusse box 202. In particular, the vehicle safety warning control system 200 may be plugged into a brake light fuse slot 204 of the fuse box 202 to provide the control system described above.

Referring to FIG. 5, the vehicle safety warning control system 200 includes a plug 208 configured to be plugged into the brake light fuse slot 204. One output of the plug 208 is connected to a fuse 206 which preferably has the same ampere as the brake fuse. In the present invention, a 20 amp fuse is preferred. One end of the fuse 206 is connected to a brake pedal sensor 220 and impact sensor unit 255. The brake pedal sensor is similar to the brake sensors 120 and 130 described above and detects the normal or the panic braking condition of the brake pedal.

The impact sensor unit 255 comprises the impact sensor 50 and the processor 140 described with respect to FIG. 4. The impact sensor unit 255 is preferably connected to the relay 250 and the emergency transmitter, a door lock control and hazard lights.

According to the second embodiment, the output of the relay 250 is connected to a flasher 260 that controls the on-off timing of the brake lights. In addition to the existing vehicle lights, such as auxiliary light, brake lights, hazard lights, back-up lights, the preferred embodiment may also include a strobe light 272 and a pilot lamp 274 as additional lighting source to warn other drivers. The strobe light 272 may be enabled during panic braking situation and when the impact sensor 255 is triggered. The strobe light 272 is preferably disabled during normal braking situation. The pilot lamp 274 may be synchronously enabled when the brake lights are enabled. Both the strobe light 272 and the pilot lamp 274 may be installed in any location of the vehicle that is readily visible to other drivers or pedestrians. Such location may include on top of the dash board or behind the rear seats.

FIG. 6 illustrates a schematic diagram of the vehicle safety warning control system 300 according to a third embodiment of the present invention. The third embodiment is similar in many aspect to the second embodiment except is it is preferably designed for a factory installation.

Referring to FIG. 6, the vehicle safety warning control system 300 is connected to the brake fuse line and cigarette fuse line. The vehicle safety warning control system 300 includes a pair of fuses 302 and 304 connected to the brake fuse line and the cigarette fuse line. One end of the first fuse 302 is connected to a brake pedal sensor 320 and a relay 350. One end of the second fuse 304 is connected to an accelerator pedal sensor 310 and an impact sensor 355. The accelerator pedal sensor 310 is similar to the accelerator sensor 110 described in connection with FIG. 4. The accelerator pedal sensor 310 detects the removal of foot from the accelerator that is equipped with a sensor switch 14 described in connection with FIG. 1. In particular, when the removal of foot from the accelerator pedal is detected by the accelerator pedal sensor 310, the brake light is immediately turned on, preferably at a one-half intensity, to warn near by drivers that the vehicle is slowing down.

According to FIG. 6, the brake pedal sensor 320 is connected to the relay 350 to energize the relay when braking is detected. In the preferred embodiment, the brake pedal sensor 320 is similar to the brake sensors 120 and 130 described above and detects the normal or the panic braking condition of the brake pedal.

The impact sensor unit 355 comprises the impact sensor 50 and the processor 140 described with respect to FIG. 4. The impact sensor unit 355 is preferably connected to the relay 250 and the emergency transmitter, a door lock control and hazard lights.

According to the third embodiment, the output of the relay 350 is connected to a flasher 360 that controls the on-off timing of the brake lights. In addition to the existing vehicle lights, such as auxiliary light, brake lights, hazard lights, back-up lights, the preferred embodiment may also include a strobe light 372 and a pilot lamp 374 as additional lighting source to warn other drivers. The strobe light 372 may be enabled during panic braking situation and when the impact sensor 355 is triggered. The strobe light 372 is preferably disabled during normal braking situation. The pilot lamp 374 may be synchronously enabled when the brake lights are enabled.

It will be apparent to those skilled in the art that various modifications and variations can be made in the present invention without departing from the spirit or scope of the invention.

Thus, it is intended that the present invention cover the modifications and variations of this invention provided they come within the scope of the appended claims and their equivalents.

What is claimed is:

1. A vehicle safety warning control system for use with a fuse box having a brake light fuse, the vehicle lighting control system comprising:
a brake pedal sensor associated with a brake pedal to detect a normal braking and a panic braking;
an impact sensor comprising an impact switch and a processor to detect collision; and
a relay connected to the brake pedal sensor and the impact sensor, wherein the relay controls at least one of brake lights and additional lights in response to the brake pedal sensor and the impact sensor.

2. The vehicle safety warning control system of claim 1, further comprising a flasher connected to the relay, the flasher being energized in response to outputs of the brake pedal sensor and the impact sensor.

3. The vehicle safety warning control system of claim 1, wherein the additional light is a strobe light.

4. The vehicle safety warning control system of claim 1, wherein when the brake pedal sensor detects the panic braking, the relay energizes the additional lights.

5. The vehicle safety warning control system of claim 1, wherein the impact sensor is triggered by an airbag switch.

6. The vehicle safety warning control system of claim 1, wherein when the impact switch is triggered, the processor activates at least one of hazard lights, emergency transmitter and door unlock mechanism.

7. A vehicle safety warning control system for use with a fuse box having a brake light fuse, the vehicle lighting control system comprising:
an accelerator pedal sensor associated with an accelerator pedal;
a brake pedal sensor associated with a brake pedal to detect a normal braking and a panic braking;
an impact sensor comprising an impact switch and a processor to detect collision; and
a relay connected to the accelerator pedal sensor, the brake pedal sensor and the impact sensor, wherein the relay controls at least one of brake lights and additional lights in response to the brake pedal sensor and the impact sensor.

8. The vehicle safety warning control system of claim 7, wherein the accelerator pedal has a sensor switch disposed on the accelerator pedal to detect removal of pressure imposed thereon.

9. The vehicle safety warning control system of claim 8, wherein when the sensor switch in enabled, the accelerator pedal sensor causes the brake lights to be energized at a less than full intensity.

10. The vehicle safety warning control system of claim 7, further comprising a flasher connected to the relay, the flasher being energized in response to outputs of the brake pedal sensor and the impact sensor.

11. The vehicle safety warning control system of claim 7, wherein the additional light is a strobe light.

12. The vehicle safety warning control system of claim 7, wherein when the brake pedal sensor detects the panic braking, the relay energizes the additional lights.

13. The vehicle safety warning control system of claim 7, wherein the impact sensor is triggered by an airbag switch.

14. The vehicle safety warning control system of claim 7, wherein when the impact switch is triggered, the processor activates at least one of hazard lights, emergency transmitter and door unlock mechanism.
